(19) United States
(12) Patent Application Publication
(10) Pub. No.: US 2010/0218180 A1
(43) Pub. Date: Aug. 26, 2010

(54) Method, a system and a computer program product for updating applications using data embedded in downloaded content

(75) Inventor: Ram Cohen, Tel Aviv (IL)

Correspondence Address: ROBERT G. LEV, 4766 MICHIGAN BLVD., YOUNGSTOWN, OH, 44505, US

(73) Assignee: PostalGuard Ltd., Petah Tikva (IL)

(21) Appl. No.: 12/660,228

(22) Filed: Feb. 23, 2010

Related U.S. Application Data
(60) Provisional application No. 61/154,446, filed on Feb. 23, 2009.

(51) Int. Cl. G06F 9/44

(52) U.S. Cl. 717/173

(57) ABSTRACT

A method for a provider to update a user application comprising the steps of: providing a monitor for monitoring content streaming to the user system, monitoring the content streaming to the user system and detecting an update data block and selectively updating an application in accordance with the data block.

### PRIORITY

The present invention claims priority from U.S. Provisional Application No. 61/154,446 filed Feb. 23, 2010, making reference herein to same in its entirety.

### FIELD OF THE INVENTION

The present invention is directed to updating software applications over networks, particularly but not exclusively to updating applications over the Internet.

### BACKGROUND

In the modern world, ever increases numbers of transactions and services are provided on line over the Internet. Such services may require a dedicated application to be loaded onto the user system. Sometimes, the required application is first installed when the user subscribes to the service.

Examples of such services includes internet banking, networked pharmacists, doctors surgeries, professional service providers operating opposite government agencies, such as accountants and registered tax consultants opposite the tax offices, attorneys opposite the courts, patent attorneys opposite the patent office, and the like.

By way of example, an account holder wishing to access his account over the Internet may download an application when first accessing a bank account via the Internet.

Frequently neither the service provider nor the customer nor the end user is particularly computer savvy. They see the underlying technology as a means to an end and want as little to do with it's maintenance as possible. However, from time to time, such applications require updating. Updates may be for the application execution code itself, for examples to fix bugs in the code or to add new functionality to the software . . . Updates may also be for the configuration of the application, i.e. to the data that the application uses when interacting with the user. For example, for a banking application, the configuration update may include updated currency exchange rates. Furthermore, there is often a need to deliver user specific configuration updates, for example, the current balance in the banking account of the client. For these and other reasons, it may be necessary to update the application.

There is a need to enable providers to push updates to users, particularly active users. By updates, changes to data and/or to programming code are intended. The present invention addresses this need.

### SUMMARY OF THE INVENTION

The present invention is directed to a method for a provider to update a user application comprising the steps of: providing a user system with a monitor for monitoring content streaming to the user system; monitoring the content streaming to the user system and detecting an update data block, and selectively updating an application in accordance with the data block.

Typically, the method further comprises the step of validating the data block.

The step of validating typically comprises at least one of the group consisting of: checking a digital signature of the data block; checking internal integrity of the data block and checking conformity between the data block or a hash or other transformation thereof, and a URL associated with the application.

Typically, the method further comprises the step of transforming the data block.

Typically, the step of transforming comprises at least one of the group consisting of decoding, decrypting and decompressing the data block.

Optionally, the step of transforming comprises obtaining additional parameters.

Optionally, the method further comprises the step of obtaining user approval for the update.

Optionally, the method further comprises the step of notifying the user of the update.

Optionally, the method further comprises the step of notifying the provider of installing/activating/implementing the update.

Optionally, the application is updated using data obtained via a URL within the data block.

Typically, the monitor is selected from the group consisting of browsers, plug ins to browsers, add-ons to browsers, tool bars, applets for browsers, e-mail applications, plug-ins to e-mail applications, add-ons to e-mail applications, stand alone clients, operating system network driver, organization gateways and proxy servers.

Optionally, the update is downloaded to the application as content in response to the user browsing a website.

Typically, the content streaming to the user comprises at least one of the group consisting of HTML pages, video files, audio files and image files.

Optionally the content streaming is downloaded from the provider to the user system.

Optionally the content streaming to the user system is downloaded to the user system responsive to a user action that is optionally selected from the group consisting of browsing a URL and selecting and activating a link in a web page.

Alternatively, the user action may comprise selecting a link in a message. That is optionally selected from the group consisting of mail messages, instant messages, social networking updates for services such as Facebook® and Tweeter®, and Short Messaging Service messages (SMS).

Typically, the detecting is facilitating by the data block comprising an identifying structure.

Optionally, the identifying structure has predefined textual start and stop markers defining its boundaries.

Optionally, the data block is embedded in an HTML comment. In some embodiments and configurations the data block is streamed to compatible user systems only.

In some embodiments and configurations the data block is streamed to all user systems but is detectable by compatible systems only.

Typically updating comprises at least one of the group consisting of: updating code of an application; installing a new application, executing an application, updating data files of an application, and updating application settings.

In one embodiment, the monitor updates itself. Additionally or alternatively, the monitor updates a separate application.

Optionally the data block comprises a link such as a URL from which to obtain additional update data.

Optionally the data block comprises the update.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. The description taken with the drawings will make apparent to those skilled in the art how the several foams of the invention may be embodied in practice. In the accompanying drawings:

FIG. 1 is a flowchart of steps of a method in accordance with a preferred embodiment of the invention;

FIG. 2 is an illustrative schematic, functional block diagram of a generalized system for use with the method of FIG. 1, and

FIG. 3 is a schematic illustration of content including a data block for updating the system of FIG. 2 in accordance with the method of FIG. 1.

### DESCRIPTION OF PREFERRED EMBODIMENTS

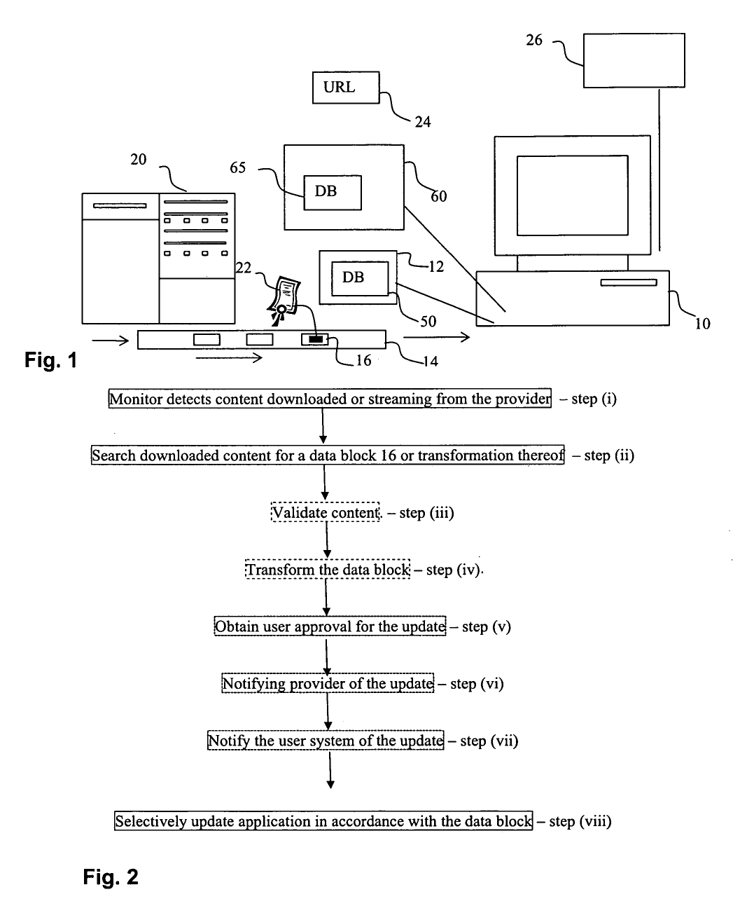

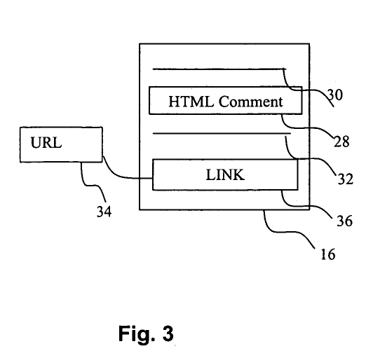

For clarity, a generalized method is shown in FIG. 1 and a generalized system for illustrative purposes is shown in FIG. 2. In FIG. 1, optional steps are indicated by dashed lines and basic steps are indicated by solid lines. In the present invention, a computer application 60 on a user terminal 10 is updated by a provider 20 pushing an update to the user terminal 10 when in communication with the provider 20. By ‘updating’, the code of the application 60, data files of the application 60, and/or application settings may be intended.

In one embodiment, the method is as follows: firstly, a monitoring program or module, henceforth monitor 12 on the user system 10 detects content 14 downloaded or streaming from the provider 20—step (i).

As shown in FIG. 3, the downloaded content 14 is searched for specific markers, such as, for example, start 30 and end markers 32 indicating a data block 16 for updating the application 60—step (ii). When a data block 16 is positively identified as including updating instructions, the content thereof 16 is typically validated; for example by checking a digital signature 22, checking internal integrity of the data block 16 and/or checking conformity between the data block 16 and a URL 24 associated with the application.—step (iii). Next, optionally the data block 16 is ‘transformed’, by, decoding, decrypting or decompressing—step (iv). User approval for the update may be obtained—step (v) and/or the user is notified of the update—step (vi). Likewise, the service provider or the server 60 may be notified of the update—step (vii). In one embodiment, the monitor 12 monitors the content 14 for the data block 16 and as content is downloaded to the user system 10 when the user system 10 is logged onto a website 26 and the application is selectively updated with data extracted from the data block 16—step (vi). The user system 10 is then notified of the update—step (viii).

The method may be implemented in response to a user action such as the user browsing a URL 34, clicking a link in a web page 26, and the like. Alternatively, the content 14 may be streamed past the monitor 12 and the act of detecting a data block 16 causes it to be opened and the update therein to be implemented.

As shown in FIG. 3, the data block 16 typically includes an identifying structure such as an HTML comment 28 with predefined textual start 30 and stop markers 32 defining its boundaries. The data block 16 may include the update embedded therein or may include a link 36 to updating code for updating the application, such as a link 36 within the data block 16, to a URL 34.

The monitor 12 that performs the block detection 16 and transformation may be configured as a plug in to a web-browser. It may be a separate program or unit, or a patch; an add on to a browser or e-mail application, a tool bar, an applet for a browser, a stand alone client, an organization gateway, a proxy server etc., initiates and performs the download to itself.

The updating may be to the monitor 12 itself, i.e. it updates a database DB 50, such as a list or table therein or associated therewith, or activates some computer code thereof to reconfigure itself in some manner. Alternatively, the monitor 12 may reconfigure a separate application 60 which could include a database 65 such as a list or table having data that is updated or the application 60 may be some program in data communication with the monitor 12 whose operating code is updated. It will be noted that the application 60, need not even be installed on the same computer as the monitor 12, and may be remote to the user system 10, but in data communication therewith.

In this manner, a provider 20, such as a network manager could update programs on users of a network such as a LAN or WAN. Indeed, the application 60 need not even be installed on the user system 10, so long as it is in data contact therewith. It will be noted that the methods of the invention are, however, of particular applicability and suitability for service providers 20 over the Internet.

By way of example, the service provider is a bank and the user initiates communication with the bank by logging on via the Internet and identifying him/herself by providing name, password, account details and the like. The provider, in this case the bank, embeds a data block as an HTML comment in the web page displayed to the user. A monitor, in this case, typically a browser plug-in, detects the data block within the HTML page and validates it A window is displayed to the user, offering him the opportunity to accept an update. The user accepts this opportunity by selectively clicking on an ACCEPT button. The plug-in continues to update the required application with information from the data block. The required application may be the plug-in itself or a different application on the client machine.

The update could be factual data such as account details like bank balances and prearranged standing orders, which would typically be used to update a list, table or other database. The update could be settings such as permissions for overdrafts or purchasing abroad. The update can also be executable code for correcting or improving the application, and providing additional functionality.

The application may be updated from the provider website, or a separate URL may be downloaded to the user system as part of the data block.

Where the provider is accessible by a range of users, not all of them having applications or applications requiring updating, the data block used for updating may be selectively displayable only to compatible user systems.

The content downloaded to the user system that is monitored by the monitor for a data block of instructions may be in a wide range of data types, including, for example, HTML pages, video files, audio files and image files.

Thus a method, system and computer program for updating applications using data embedded in downloaded content has been described. The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method for a provider to update a user application comprising the steps of:
(i) providing a monitor for monitoring content streaming to the user system;
(ii) Monitoring the content streaming to the user system and detecting an update data block;
(viii) selectively updating the application in accordance with the data block.

2. The method of claim 1 further comprising step (iii) of validating the data block.

3. The method of claim 2 wherein step (iii) of validating comprises at least one of the group consisting of:
checking a digital signature of the data block;
checking internal integrity of the data block;
checking conformity between the data block or a hash or other transformation of, and a URL associated with the application.

4. The method of claim 1 further comprising step (iv) of translating the data block.

5. The method of claim 4 wherein the step of translating comprises at least one of the group consisting of decoding, decrypting and decompressing the data block.

6. The method of claim 5 wherein the step of translating comprises obtaining additional parameters.

7. The method of claim 1 further comprises at least one of the following steps:
step (v) of obtaining user approval for the update; step (vi) of notifying service provider of the update.

8. The method of claim 1 further comprising step (vii) of notifying the user of the update.

9. The method of claim 8 wherein provider is updated via a URL within the data block.

10. The method of claim 1 wherein monitor is selected from the group consisting of browsers, plug ins to browsers, add-ons to browsers, tool bars, applets for browsers, e-mail applications, plug-ins to e-mail applications, add-ons to e-mail applications, stand alone clients, operating system network driver, organization gateways and proxy servers.

11. The method of claim 1 wherein the update is downloaded to the application as content in response to the user browsing a website.

12. The method of claim 1, wherein the content streaming to the user comprises at least one of the group consisting of HTML pages, video files, audio files and image files.

13. The method of claim 1 wherein the content streaming is downloaded from the provider to the user system.

14. The method of claim 1 wherein the content streaming to the user system is downloaded to the user system responsive to a user action.

15. The method of claim 14 wherein the user action is selected from the group consisting of browsing a URL and selecting and activating a link in a web page.

16. The method of claim 14 wherein the user action comprises selecting a link in a message.

17. The method of claim 16 wherein the message is selected from the group consisting of mail messages, social networking updates for services such as Facebook® and Tweeter®, instant messages and SMS.

18. The method of claim 1 wherein the detecting is facilitating by the data block comprising an identifying structure.

19. The method of claim 18 wherein at least one of the following qualifiers is true: (a) the identifying structure has predefined start and stop markers defining its boundaries;
(b) the data block is embedded within an HTML comment

20. The method of claim 1 wherein at least one of the following qualifiers is true:
(w) the data block is streamed to compatible user systems only; (x) wherein the data block is streamed to all user systems but is detectable by compatible systems only; (y) the updating comprises at least one of the group consisting of: updating code of an application; installing a new application;
executing an application; updating data files of application, and updating application settings.

21. The method of claim 1 wherein the monitor updates itself.

22. The method of claim 1 wherein updates a separate application selected from the group consisting of browsers, plug ins to browsers, add-ons to browsers, tool bars, applets for browsers, e-mail applications, plug-ins to e-mail applications, add-ons to e-mail applications, stand alone clients, operating system network driver, organization gateways and proxy servers.

23. The method of claim 1 wherein the monitor updates a separate application.

24. The method of claim 1 wherein the data block either comprises a link such as a URL from which to obtain additional update data or the data block comprises the update.
